(19) United States
(12) Patent Application Publication
(10) Pub. No.: US 2020/0130426 A1
(43) Pub. Date: Apr. 30, 2020

(54) BEAD MEMBER MANUFACTURING METHOD, A BEAD MEMBER AND A PNEUMATIC TIRE

(71) Applicant: Toyo Tire Corporation, Itami-shi (JP)

(72) Inventor: Atsushi Nakanishi, Itami-shi (JP)

(73) Assignee: Toyo Tire Corporation, Itami-shi (JP)

(21) Appl. No.: 16/437,622

(22) Filed: Jun. 11, 2019

(30) Foreign Application Priority Data
Oct. 30, 2018 (JP) 2018-204097

(51) Int. Cl. B60C 15/06; B60C 15/04; B29D 30/48

(52) U.S. Cl. CPC B60C 15/06; B60C 2015/044; B29D 30/48; B60C 15/04

(57) ABSTRACT

A bead member manufacturing method in the present invention includes a bead core forming step of winding and stacking a bead wire from a winding start end to a winding finish end and forming a bead core having an annular shape, the bead wire being formed by coating an outer circumferential surface of a metal wire with a topping rubber; and a bead wire banding step of winding a tape-shaped rubber around one or both of the winding start end and the winding finish end, wherein tackiness of the tape-shaped rubber is higher than tackiness of the topping rubber.

### TECHNICAL FIELD

The present invention relates to a bead member manufacturing method, a bead member and a pneumatic tire.

### DESCRIPTION OF THE RELATED ART

For a pneumatic tire, used is an annular bead core formed by winding and stacking bead wires composed by coating metal wires with a topping rubber. For example, Patent Document 1 discloses an annular bead core formed by winding and stacking strands, each of which is composed by arraying a plurality of bead wires, and each of Patent Documents 2 and 3 describes an annular bead core formed by winding and stacking a single bead wire. Such an annular bead core as described above has a winding start end and winding finish end of the bead wire. In a process of manufacturing a bead member including the bead core, the winding start end and the winding finish end sometimes project to an outer diameter side of the annular bead core. Accordingly, as in Patent Documents 2 and 3, there is known a method of winding a string or cord, which is formed of organic fiber such as polyester, around the winding start end and the winding finish end, banding the bead wire, thereby suppressing such projection as described above.

However, it is necessary to increase the number of winding the string or the cord in order to increase a suppression force for the projection of the winding start end and the winding finish end. Then, as the number of winding the string or the cord is increased, the wound string or cord tends to divide the bead core and a bead filler that is in contact with the bead core and incorporated in the tire, and to reduce adhesiveness between the bead core and the bead filler.

Patent Document 4 describes a device for winding a rubber tape to a bead core. However, Patent Document 4 relates to a technology for smoothly peeling off the rubber tape from an outer circumferential surface of a drum, and does not suggest means for solving the above-mentioned problem regarding the adhesiveness between the bead core and the bead filler.

### PRIOR ART DOCUMENTS

### Patent Documents

Patent Document 1: JP-A-2005-254885

Patent Document 2: JP-A-2017-177487

Patent Document 3: JP-A-2016-088256

Patent Document 4: JP-A-2017-001243

### SUMMARY OF THE INVENTION

It is an object of the present invention to provide a bead member which is capable of suppressing the projection of the winding start end and the winding finish end of the bead wire and is further excellent in the adhesiveness between the bead core and the bead filler.

A bead member manufacturing method in the present invention comprises a bead core forming step of winding and stacking a bead wire from a winding start end to a winding finish end and forming a bead core having an annular shape, the bead wire being formed by coating an outer circumferential surface of a metal wire with a topping rubber; and a bead wire banding step of winding a tape-shaped rubber around one or both of the winding start end and the winding finish end, wherein tackiness of the tape-shaped rubber is higher than tackiness of the topping rubber.

In accordance with such a configuration, the following effect is obtained.

The tape-shaped rubber is wound, whereby the projection of the winding start end and the winding finish end of the bead wire can be suppressed. Then, tackiness of the tape-shaped rubber is higher than tackiness of the topping rubber, and accordingly, the adhesiveness between the bead core and the bead filler is improved when this tape-shaped rubber is wound around the bead core.

A length of the tape-shaped rubber wound in the bead wire banding step, the length going along a circumferential direction of the bead core may be 10 mm or more and 50 mm or less.

A bead member in the present invention comprises a bead core having an annular shape, formed by winding and stacking a bead wire from a winding start end to a winding finish end, the bead wire being formed by coating an outer circumferential surface of a metal wire with a topping rubber; and a tape-shaped rubber wound around one or both of the winding start end and the winding finish end, wherein tackiness of the tape-shaped rubber is higher than tackiness of the topping rubber. Moreover, a pneumatic tire of the present invention comprises such the bead member.

### BRIEF DESCRIPTION OF THE DRAWINGS

FIG. 1 is a half cross-sectional view of a tire meridian, illustrating an example of a pneumatic tire;

FIG. 2 is a side view illustrating a part of a bead core in a first embodiment;

FIG. 3 is a cross-sectional view along arrows A-A in FIG. 2;

FIG. 4 is a side view illustrating a part of a bead core in a second embodiment;

FIG. 5 is a cross-sectional view of a bead core including a winding start end in a third embodiment; and

FIG. 6 is a perspective view illustrating a temperature control tool that heats the winding start end and the winding finish end in the third embodiment.

### DETAILED DESCRIPTION OF THE PREFERRED EMBODIMENTS

Embodiments of the present invention will be described with reference to the drawings.

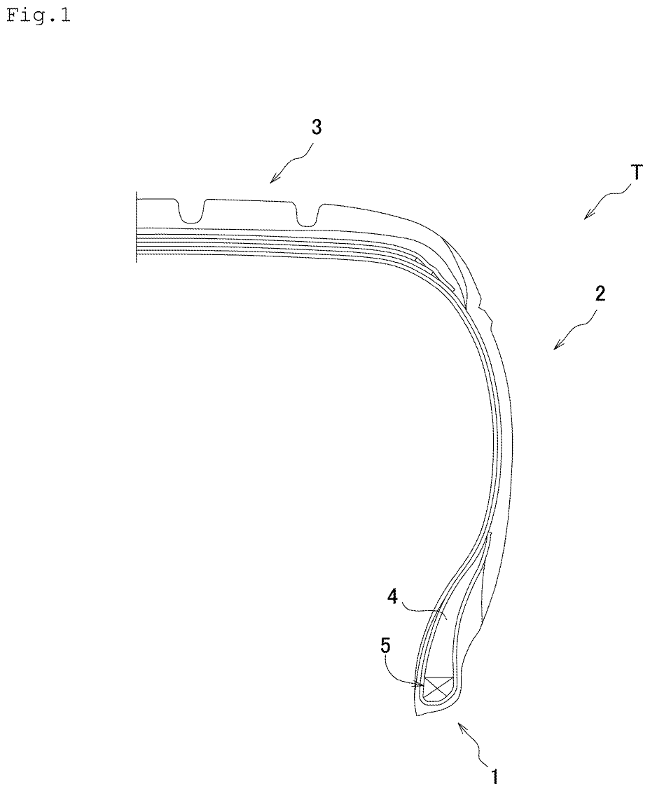

In FIG. 1, an example of a pneumatic tire already subjected to cure molding is illustrated as a half cross-sectional view of a tire meridian. A pneumatic tire T includes: a pair of bead portions 1; sidewall portions 2, each of which extends outside in a tire diameter direction from each of the bead portions 1; and a tread portion 3 continuous with outside ends in the tire diameter direction of the respective sidewall portions 2. A bead member is embedded in each of the bead portions 1. The bead member includes: an annular bead core 5; and a bead filler 4 made of hard rubber. The bead filler 4 is disposed in contact with an outside in the tire diameter direction of the bead core 5.

### First Embodiment

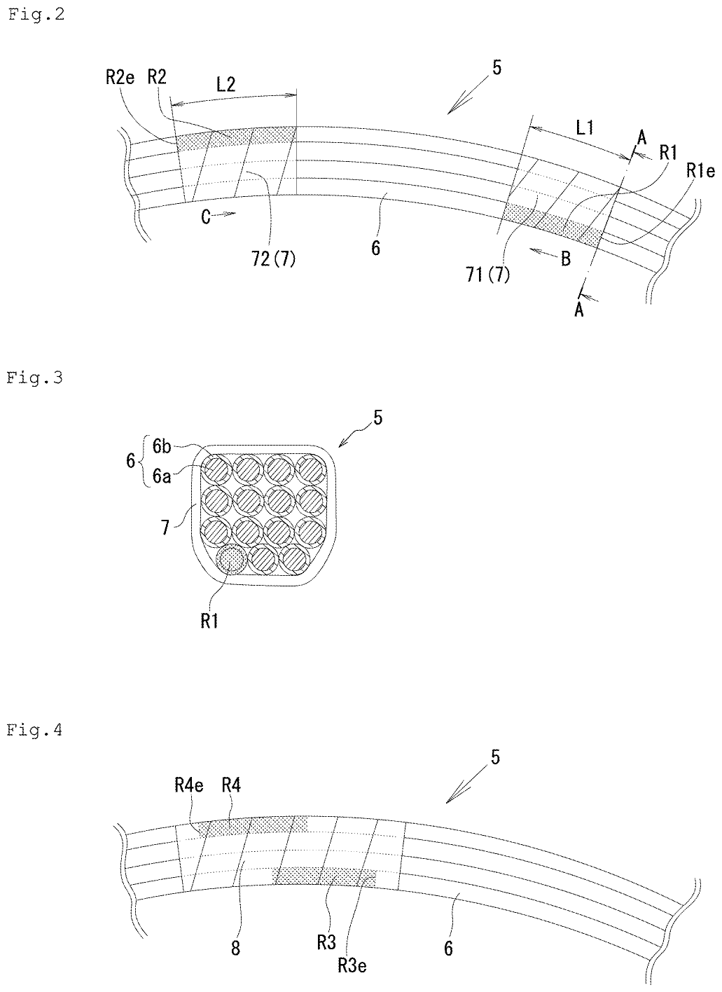

FIG. 2 illustrates a portion of the bead core 5 in the first embodiment. The portion includes winding start ends and winding finish ends of bead wires. FIG. 3 is a cross-sectional view along arrows A-A in FIG. 2. The bead core 5 is formed by winding and stacking a bead wire 6. The number of stages of the bead wires 6 to be wound and stacked, the number of lines thereof and a cross-sectional shape of the entire bead core 5 formed by winding and stacking the bead wire 6 are not limited to those in the embodiments. One end of the bead wire 6 is a winding start end R1 (a hatched region), and other end thereof is a winding finish end R2 (a hatched region). A tape-shaped rubber 7 having a thin and long band shape is wound around a region of the bead core 5, which includes the winding start end R1, whereby the bead wires 6 are banded together, and projection of the winding start end R1 of the bead wire 6 can be suppressed. A tape-shaped rubber 7 is also wound around a region of the bead core 5, which includes the winding finish end R2, whereby projection of the winding finish end R2 of the bead wire 6 can be suppressed in a similar way. Hence, it is not necessary, as heretofore, to wind a string or cord which is made of organic fiber such as polyester. However, in order to strengthen the banding, the tape-shaped rubbers 7 may be wound after the string or the cord is wound to an extent of not completely dividing the bead core 5 and the bead filler 4 from each other.

Moreover, as mentioned above, when the string or the cord which is made of organic fiber such as polyester is wound, the wound string or cord tends to divide the bead core 5 and the bead filler 4 that is in contact with the bead core 5 and incorporated in the tire, and to reduce adhesiveness between the bead core 5 and the bead filler 4. This results from the fact that tackiness of the string or the cord which is made of organic fiber is smaller than tackiness of the topping rubber 6b. The tackiness refers to an adhesive force, that is, a force required for peeling, and large tackiness brings excellent adhesiveness. In the case of the present invention, tackiness of the tape-shaped rubber 7 is higher than the tackiness of the topping rubber 6b. Therefore, the bead core 5 around which the tape-shaped rubber 7 is wound is superior in adhesiveness to the bead filler 4 to a bead core around which the string or the cord which is made of organic fiber is wound and to a bead core around which nothing is wound.

A manufacturing method of the bead member will be described. First, still uncured topping rubber 6b is applied on an outer circumferential surface of the metal wire 6a such as a steel wire, whereby the bead wire 6 is manufactured. For example, the metal wires 6a are sequentially passed near a mouthpiece of a rubber extruder that ejects the topping rubber 6b, whereby the topping rubber 6b can be applied on the outer circumferential surfaces of the metal wires 6a. It is preferable that a thickness of the topping rubber 6b be, for example, 0.1 mm to 0.3 mm, and the thickness is controlled, for example, by adjusting a bore of the mouthpiece of the rubber extruder.

Next, as a bead core forming step, the bead wire 6 is wound and stacked in an annular shape from the winding start end R1 to the winding finish end R2, whereby the bead core 5 is formed. In order that a wound and stacked portion is generated in the bead wire 6, the bead wire 6 is wound so as to make at least more than a single lap.

Then, as a bead wire banding step, the tape-shaped rubber 7 having a thin and long band shape is wound so as to cover each of the winding start end R1 and the winding finish end R2. Moreover, the tape-shaped rubber 7 may be wound around only either one of the winding start end R1 and the winding finish end R2. In FIG. 2, the tape-shaped rubber 7 wound around the winding start end R1 is defined as a “tape-shaped rubber 71”, the tape-shaped rubber 7 wound around the winding finish end R2 is defined as a “tape-shaped rubber 72”, and these are illustrated to be distinguished from each other.

In the first embodiment, the tape-shaped rubber 71 is wound a plurality of times in a spiral shape in a direction of winding the bead wire 6 (in a direction B in FIG. 2) from a tip end R1e of the winding start end R1 (a hatched region). Moreover, the tape-shaped rubber 72 is wound a plurality of times in a spiral shape in a direction opposite to the direction of winding the bead wire 6 (in a direction C in FIG. 2) from a terminal end R2e of the winding finish end R2. When the tape-shaped rubber 71 and the tape-shaped rubber 72 are wound as described above, unwound portions do not occur on the tip end R1e of the winding start end R1 and the terminal end R2e of the winding finish end R2.

When the tape-shaped rubber 7 is wound, there may be adopted not the method of winding the same in a spiral shape but a method of newly winding the tape-shaped rubber 7 at a position shifted in the direction of winding the bead wire 6 while winding the tape-shaped rubber 7 in a direction perpendicular to the direction of winding the bead wire 6. Moreover, the tape-shaped rubber 7 may be wound while stacking a part thereof in a circumferential direction of the bead core 5, or may be wound so as to eliminate such stacking of the tape-shaped rubber 7 itself in the circumferential direction as much as possible. When the tape-shaped rubber 7 is wound while being stacked, a thickness of the tape-shaped rubber 7 is increased to enhance strength of the tape-shaped rubber 7, and the effect of suppressing the projection of the bead wire 6 is increased. Meanwhile, a weight balance between the portion around which the tape-shaped rubber 7 is wound while being stacked and the portion around which the tape-shaped rubber 7 is not wound is prone to deteriorate.

In order to enhance the tackiness, the tape-shaped rubber 7 is formed by adding a tackifier to a raw material of rubber and kneading. As the tackifier, there are mentioned: a synthetic resin-based tackifier such as phenol resin and alkyl phenol resin; coumaroneindene resin; a natural resin-based tackifier such as a rosin derivative; and the like. A type and additive amount of the tackifier are set so as to obtain a desired adhesive force. It is preferable that an adhesive force (N) of the rubber for use in the tape-shaped rubber 7 be 1.5 times or more an adhesive force (N) of the topping rubber 6b. As a method for measuring the adhesive force (N), there is a method of using an adhesive force measuring device (trade name: “Tack Tester II”) made by Toyo Seiki Seisaku-sho, Ltd., pressure-bonding a test piece (pursuant to JIS T9233), which is made of measurement target rubber, onto a metal plate, for example, under conditions where a pressure bonding load is 100 g, and a pressure bonding time is 10 seconds, and measuring a force required to peel off the test piece from the metal plate at a condition where a speed is 30 mm/min. By such a measurement method, relationships between the type and additive amount of the tackifier and a measured value of the adhesive force are found, and a type and additive amount of the tackifier, which cause the adhesive force (N) of the rubber for use in the tape-shaped rubber 7 to have an adhesive force 1.5 times or more the adhesive force (N) of the topping rubber 6b, are calculated. It is preferable that the tape-shaped rubber 7 be produced by adding the tackifier thereto on the basis of a calculation result.

It is preferable that a winding length L1 of the tape-shaped rubber 71 be 10 mm or more and 50 mm or less. This length L1 is a length of the tape-shaped rubber 71 along the circumferential direction of the bead core on an outermost side of the annular bead core. When the winding length of the tape-shaped rubber 71 is increased, a balance is prone to be lost from a weight of the bead core 5. When the winding length of the tape-shaped rubber 71 is decreased, the effect of suppressing the projection of the winding start end R1 of the bead wire 6 is small, and the effect of enhancing the adhesiveness of the bead core 5 to the bead filler 4 is reduced. When L1 stays within the above-described numerical value range, while ensuring the weight balance, the effect of suppressing the projection of the winding start end R1 and the adhesiveness of the bead core 5 to the bead filler 4 can be enhanced sufficiently. Moreover, likewise, it is preferable that a winding length L2 of the tape-shaped rubber 72 also be 10 mm or more and 50 mm or less. This length L2 is a length of the tape-shaped rubber 72 along the circumferential direction of the bead core on the outermost side of the annular bead core.

After the bead wire banding step, the bead filler 4 is attached to the outside in the tire diameter direction of the bead core 5 as a bead filler forming step. Specifically, for example, uncured rubber is extruded into a predetermined cross-sectional shape by using the rubber extruder, and such a rubber-extruded product is cut into a predetermined length, end portions of the cut rubber-extruded product are joined to each other, whereby the rubber-extruded product is formed into an annular shape, and the bead filler 4 is adhered to an outer circumference of the bead core 5.

A green tire in which the bead member including the above-described bead core 5 and the bead filler 4 is embedded in the bead portion 1 is formed, and is subjected to cure molding, whereby a pneumatic tire is manufactured. A pneumatic tire which contains a particularly large amount of tackifier component in one or both of a bead wire winding start end and a bead wire winding finish end certifies that the tape-shaped rubber having higher tackiness than tackiness of the topping rubber is used at the time when the pneumatic tire is manufactured.

### Second Embodiment

A second embodiment has a similar configuration to that of the first embodiment except for a configuration to be described below, and accordingly, a description of points common therebetween is omitted, and points different therebetween are mainly described. The same reference numerals are assigned to the same members as the members described in the first embodiment, and a duplicate description is omitted. Moreover, it is possible to adopt a plurality of described modified examples in combination without particular limitations. The above is also applied to third and fourth embodiments.

The second embodiment is described with reference to FIG. 4. In this embodiment, a winding start end R3 and a winding finish end R4 are close to each other to an extent where a part of the winding start end R3 and a part of the winding finish end R4 overlap each other in the circumferential direction of the bead core. Therefore, the winding start end R3 and the winding finish end R4 are wound by a single tape-shaped rubber 8. The tape-shaped rubber 8 wound around the whole of the bead core is saved to be short, and accordingly, it is easy to ensure the weight balance.

Moreover, as seen in FIG. 4, the tape-shaped rubber 8 may be wound so as to cover a tip end R3e of the winding start end R3 and a tip end R4e of the winding finish end R4. When the tape-shaped rubber 8 is wound as described above, a high effect of suppressing projection of the winding start end R3 and the winding finish end R4 is brought.

### Third Embodiment

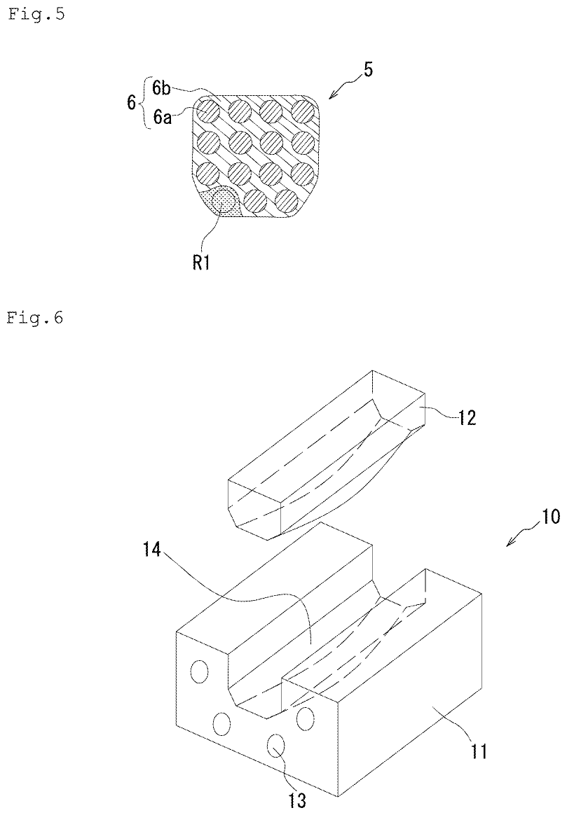

A third embodiment is described with reference to FIG. 5 and FIG. 6. In this embodiment, after the bead wire banding step, a region including one or both of the winding start end and the winding finish end of the bead wire 6 in the annular bead core 5 is heated, and topping rubbers 6b of adjacent metal wires 6a are fused to one another. FIG. 5 illustrates a cross-sectional view of the bead core 5 subjected to such a heating step as described above. It is preferable to perform the heating step before the bead filler forming step. When the topping rubbers 6b of the adjacent metal wires 6a are fused to one another, the metal wires 6a are fixed with ease, and the winding start end and the winding finish end of the bead wire 6 can be further suppressed from projecting to the outer diameter side of the annular bead core 5.

It is preferable that a heating temperature be 60° C. or more at which the topping rubbers 6b are sufficiently fused and 90° C. or less at which a degradation phenomenon called bloom does not occur. It is preferable that the topping rubbers 6b be in an uncured state. The state where the topping rubbers 6b are uncured is not limited to a state where no cure reaction advances, but includes a so-called semi-cure state and a state equivalent to insufficient cure defined by JIS K 6200 (a cure state that does not reach the optimum cure).

An example of a method for heating the region including one or both of the winding start end and the winding finish end of the bead wire 6 is described with reference to FIG. 6. FIG. 6 discloses a temperature control tool 10 for heating the winding start end and the winding finish end. The temperature control tool 10 includes: a metal die 11 having a groove 14 to which the bead core 5 including the winding start end and the winding finish end is set; and a lid 12 fitted to the groove 14 after the bead core 5 is set to the groove 14. In the groove 14, a center thereof is smoothly dented in matching with the annular shape of the bead core 5. Pipes 13 are provided in the metal die 11, and a temperature of the metal die 11 is adjusted in such a manner that a heating medium passes through the pipes 13. Such pipes through which the heating medium passes may also be provided in the lid 12. On a radial cross section of the bead core 5, the temperature control tool 10 is caused to surround more than a half of an outer circumference of the cross section of the bead core 5, whereby it becomes possible to heat the whole of the outer circumference of the cross section of the bead core 5.

When the region including the winding start end or the winding finish end of the bead wire 6 is heated, the topping rubbers 6b of the adjacent metal wires 6a are fused to one another. When the topping rubbers 6b are fused to one another, such an effect of suppressing the winding start end from projecting to the outer diameter side of the annular bead core 5 is obtained. After the topping rubbers 6b are heated, a tape-shaped rubber with high tackiness is wound therearound. In this way, not only the effect of suppressing the winding start end from projecting to the outer diameter side of the annular bead core 5 is enhanced, but also the adhesiveness between the bead core 5 and the bead filler 4 is enhanced since the tape-shaped rubber 8 is interposed therebetween. It is preferable that the region including the winding finish end be heated similarly.

Moreover, a region in the bead core 5, which is other than the winding start end and the winding finish end, may be heated, or the entire circumference of the bead core 5 may be heated. It is preferable that the heated portion be wound by the tape-shaped rubber with high tackiness. Moreover, the above-described heating method is merely an example, and the bead core 5 may be heated by directly spraying a heating medium thereto, or may be given heat radiation.

### Fourth Embodiment

In the case of the above-described embodiments, in a portion in the bead core 5, which is not wound by the tape-shaped rubbers 7 and 8, the topping rubber 6b is brought into contact with the bead filler 4. In order to increase mutual cohesion of the bead wires 6, another wrapping material than the tape-shaped rubbers 7 and 8 with high tackiness may be wound around the portion that is not wound by the tape-shaped rubbers 7 and 8.

The present invention is not limited to the above-mentioned embodiments, and is improvable and modifiable in various ways within the scope without departing from the spirit of the present invention.

1. A bead member manufacturing method comprising:
a bead core forming step of winding and stacking a bead wire from a winding start end to a winding finish end and forming a bead core having an annular shape, the bead wire being formed by coating an outer circumferential surface of a metal wire with a topping rubber; and
a bead wire banding step of winding a tape-shaped rubber around one or both of the winding start end and the winding finish end,
wherein tackiness of the tape-shaped rubber is higher than tackiness of the topping rubber.

2. The bead member manufacturing method according to claim 1, wherein a length of the tape-shaped rubber wound in the bead wire banding step, the length going along a circumferential direction of the bead core, is 10 mm or more and 50 mm or less.

3. The bead member manufacturing method according to claim 1, wherein, in the bead wire banding step, the tape-shaped rubber is wound in a spiral shape a plurality of times.

4. The bead member manufacturing method according to claim 1, wherein, in the bead wire banding step, the tape-shaped rubber is wound while being stacked.

5. The bead member manufacturing method according to claim 1, wherein, in the bead wire banding step, the tape-shaped rubber that is single is wound around the winding start end and the winding finish end.

6. The bead member manufacturing method according to claim 5, wherein, in the bead wire banding step, the tape-shaped rubber is wound so as to cover a tip end of the winding start end and a tip end of the winding finish end.

7. The bead member manufacturing method according to claim 1, further comprising a heating step of heating a region including one or both of the winding start end and winding finish end of the bead wire in the bead core and fusing topping rubbers of the adjacent metal wires to one another.

8. The bead member manufacturing method according to claim 7, wherein, in the heating step, the region is heated using a temperature control tool including a metal die having a groove to which the bead core is set and a lid fitted to the groove.

9. The bead member manufacturing method according to claim 7, wherein a heating temperature in the heating step is 60° C. or more and 90° C. or less.

10. The bead member manufacturing method according to claim 1, further comprising a step of winding another wrapping material than the tape-shaped rubber around a portion around which the tape-shaped rubber is not wound.

11. A bead member comprising:
a bead core having an annular shape, formed by winding and stacking a bead wire from a winding start end to a winding finish end, the bead wire being formed by coating an outer circumferential surface of a metal wire with a topping rubber; and
a tape-shaped rubber wound around one or both of the winding start end and the winding finish end,
wherein tackiness of the tape-shaped rubber is higher than tackiness of the topping rubber.

12. The bead member according to claim 11, wherein a length of the tape-shaped rubber along a circumferential direction of the bead core is 10 mm or more and 50 mm or less.

13. The bead member according to claim 11, wherein the tape-shaped rubber is wound while being stacked.

14. The bead member according to claim 11, wherein the tape-shaped rubber that is single is wound around the winding start end and the winding finish end.

15. The bead member according to claim 11, wherein the tape-shaped rubber is wound so as to cover a tip end of the winding start end and a tip end of the winding finish end.

16. The bead member according to claim 11, wherein topping rubbers of the adjacent metal wires are fused to one another.

17. The bead member according to claim 11, wherein another wrapping material than the tape-shaped rubber is wound around a portion around which the tape-shaped rubber is not wound.

18. A pneumatic tire comprising the bead member according to claim 11.
